(19) United States
(12) Patent Application Publication
(10) Pub. No.: US 2001/0025279 A1
(43) Pub. Date: Sep. 27, 2001

(54) Method and system for planning customized menu

(76) Inventors: Lora Krulak, New York, NY (US); Helen Moynihan, New York, NY (US)

Correspondence Address: STROOCK & STROOCK & LAVAN LLP, 180 Maiden Lane, New York, NY, 10038, US

(21) Appl. No.: 09/740,689

(22) Filed: Dec. 18, 2000

Related U.S. Application Data
(60) Provisional application No. 60/171,244, filed on Dec. 16, 1999.

(51) Int. Cl. G06F 17/30

(52) U.S. Cl. 707/3; 707/104.1

(57) ABSTRACT

A method for planning a customized menu. The method comprises the steps of: gathering a user's menu criteria; building a database query custom tailored to the user's menu criteria; and returning a list of recipes that correspond to the user's menu criteria; grouping the recipes into a plurality of menus; displaying the plurality of menus. The user is prompted to pick a menu by; picking one of the plurality of menus, or creating a custom menu by mixing and matching recipes. The final version of the menu is then displayed. A system for planning a customized menu may comprise a computer system, the computer system having a database and a computing device. The computing device may be configured for performing the steps mentioned above.

### CROSS REFERENCE TO RELATED APPLICATIONS

This application claims the benefit under 35 U.S.C. Section 119(e) of U.S. Provisional Application Ser. No. 60/171,244, filed Dec. 16, 1999, presently co-pending.

### BACKGROUND OF THE INVENTION

This invention pertains to a business process and system for planning a customized menu. More particularly, this invention relates to a business process and system that utilizes the Internet to allow remote access to a database of recipes to allow a user to select and plan an event with desired culinary, taste, dietary and other restrictions.

An individual planning an event to which others are invited and at which food would be served, such as a dinner party, a brunch or a picnic, must consider many variables in planning the menu of food to be served. Among the considerations are the type of event, the type of cuisine, any dietary or nutritional restrictions, any preferred ingredients, the time available for preparation, the number of attendees, etc. Naturally, each course must not conflict with the others, and the choice of drinks must also match the food being served. Once the menu has been set and the food and drinks have been chosen, the recipes for the menu must be gathered and a complete shopping list of ingredients must be compiled and purchased. Clearly, planning and preparing the menu for an event takes considerable time and effort, which is unfortunately not always available to the person planning the event.

Accordingly, it is an object of the present invention to provide a fully integrated menu planning system that can be accessed via the Internet.

It is another object of the present invention to provide a menu planning system that can generate a recommended menu and drink list for a planned menu based upon certain stated restrictions.

It is a further object of the present invention to provide a menu planning system that can generate a complete list of ingredients for recipes chosen based upon certain stated restrictions and allow the user to purchase those ingredients over the Internet.

### SUMMARY OF THE INVENTION

The invention is an interactive menu planning service that allows a user to enter a series of domains into appropriate questionnaire boxes and retrieve a customized event menu, complete with recipes, recommended drinks, nutritional information, wine pairings and a shopping list. The system has a database of recipes for many different types of foods, within which each recipe is coded with a profile that describes certain characteristics of the recipe and the food it serves. In addition, each wine or drink is similarly coded. A user planning an event accesses the system Web site through the Internet using its web browser, and the system formats and displays screens as with any standard web browser. The system presents screens and forms to the user for input of data regarding the type of event planned, the type of food desired to be served, and dietary restrictions. The user enters the data as requested, and the system matches the data most closely to the restrictions input by the user by suggesting certain recipes that satisfy the user's desired criteria and restrictions. In addition, the menu planner system suggests drinks that match with the chosen recipes. Furthermore, the system generates a master list of groceries and ingredients needed for the event and allows the user to purchase these items on line.

### BRIEF DESCRIPTION OF THE DRAWINGS

The above and other objects and advantages of the invention will be apparent upon consideration of the following detailed description, taken in conjunction with the accompanying drawings, in which the reference characters refer to like parts throughout and in which:

FIG. 1 shows a typical hardware configuration of the environment of the system of the present invention;

FIG. 2 shows a computer system used for executing the inventive method;

FIG. 3 is an overview of the process flow of the event menu planning system featuring recipe matching;

FIG. 4 is a more detailed overview of the recipe criteria and restrictions searched by the system;

FIG. 5 is a block diagram of the structures queries of the process flow of the event menu planning system featuring recipe matching;

FIG. 6 is an overview of the process flow of the event menu planning system featuring mixology matching;

FIG. 7 is a more detailed overview of the mixology criteria and restrictions searched by the system;

FIG. 8 is a block diagram of the structures queries of the process flow of the event menu planning system featuring mixology matching;

FIG. 9 is an overview of the process flow of the event menu planning system featuring wine pairing;

FIG. 10 is a more detailed overview of the wine pairing criteria and restrictions searched by the system;

FIG. 11 is a block diagram of the structures queries of the process flow of the event menu planning system featuring wine pairing;

FIG. 12 is a diagram of the process logic for assembling choices for an event menu based upon the recipe matching, mixology matching and wine pairing choices; and

FIG. 13 is a diagram of the process logic of choosing an event menu.

### DETAILED DESCRIPTION OF THE INVENTION

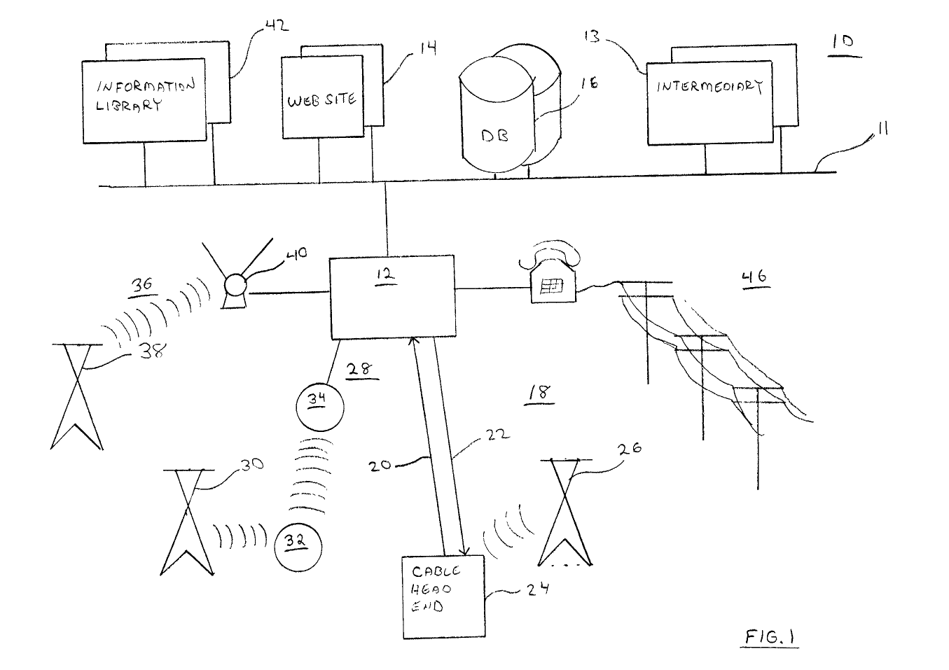

Referring now to the drawings and in particular to FIG. 1, there is shown a communications system 10, which comprises a computing device 12 for receiving and displaying data requested by the user, a network-connected device or Web site 14, and a network-connected database 16 comprising a variety of data which may be requested and communicated to network connected site 14 by the user's computing device 12. In one illustrative embodiment, the present invention may be implemented over a network 11, such as the Internet or an Intranet, and the computing device 12 may be a personal computer with an Internet browser, Internet appliance, so-called “smart” household appliance, hand-held device, personal digital assistant (PDA) or other device with network connectivity.

Additionally, computing device 12 may be connected, via down-link cable 20 and up-link cable 22, to a cable transmitting system 18 comprising a programming data source 26 for transmitting programming content, for interaction with cable head end 24 that is connected to programming data source 26, which is in turn connected to network 11. Computing device 12 may be also connected to a satellite transmitting system 28 comprising a programming data source 30 for transmitting programming content to a satellite 32, which relays the programming content to a receiving dish antenna 34 connected to computing device 12, wherein programming data source 30 is connected to network 11. Or, computing device 12 may be connected to an airwave broadcasting system 36 comprising programming data source 38 for transmitting programming content to television antenna 40 connected to the computing device 12, wherein programming data source 38 is connected to network 11. Computing device 12 may further be connected to an information library 42 comprising banks of content connected to the network 11. Finally, computing device 12 may be connected to a telephone system 34 for communicating with any of communication systems 18, 28, 36 and 42 without the use of the network 11.

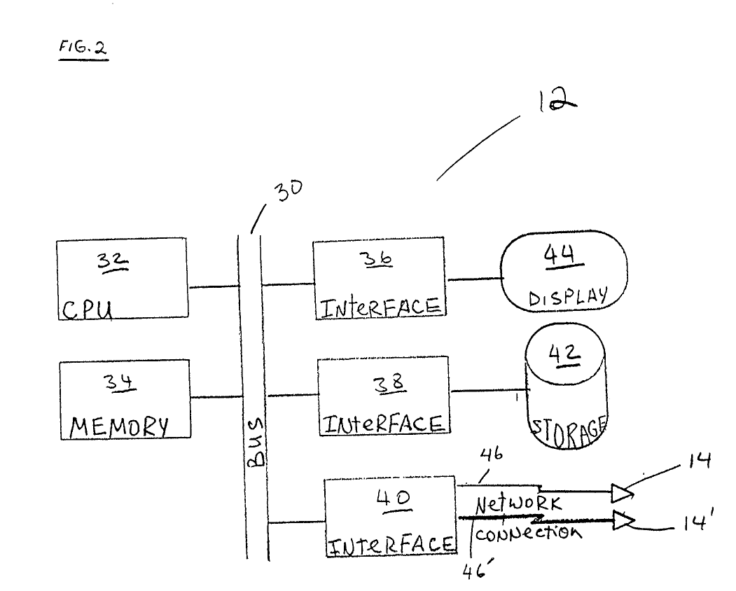

The basic configuration of each of these computing devices 12 is depicted in FIG. 2. In one illustrative embodiment, the computing device 12 comprises a bus 30, which is connected directly to each of a central processing unit (CPU) 32, a memory 34, a video interface 36, an input/output (I/O) interface 38 and a communications interface 40. The common bus 30 is connected by the I/O interface 38 to a storage device 42, which may illustratively take the form of memory gate arrays, disks, diskettes, compact disks (CD), digital video disks (DVD), etc. The video interface 36 couples a display 44 to the common bus 30. The communications interface 40 is coupled to network port 46, which can be an Internet connection such as an Internet Service Provider (ISP), which in turn is connected to network 11 and computing device 12. The transmission signal interface 60 may be connected to cables 20, 22, the satellite antenna 34 or airwave antenna 40.

The content organization such as file and record formats at Web site 14, databases 16, resource organization at data library 42 and the schedule of content transmission by systems 18, 28 and 36 may be provided by system 12 or by an intermediate entity 13. Alternatively, system 12 or intermediate entity 13 may provide rules for forming or for transmitting such content. In this case, the content to be provided is a list of recipes for various items of prepared food and drinks. System 12 accepts input from various sources and processes it according to defined business rules, such as by organizing data as needed. The recipes and drinks are input into the database, and each recipe is coded so that a recipe may be located on the basis of various predefined criteria. In one manner of coding, each recipe that is input into the database has a recipe profile associated with it in which certain terms are searchable.

For example, each recipe that is entered as an item into the database preferably is has a list of ingredients, step by step instructions and directions for preparation of the food item, diagrams of the food items in various stages of preparation, nutritional information (in various degrees of exactitude). In addition, each recipe is coded with certain searchable fields. Among these fields may be the following:

Food nationality or type

Preferred service course or occasion

List of ingredients

Nutritional content

Time of preparation

Degree of difficulty of preparation

In addition, each wine or drink that is input to the database will be coded with a complement rating that allows the wine or drink to be matched with recipes that have been chosen by the user. All food and recipe data is input into the databases and is coded to allow access by the system search engines, which seek to match the proper food recipes and drinks to the combination of criteria and restrictions selected by the user.

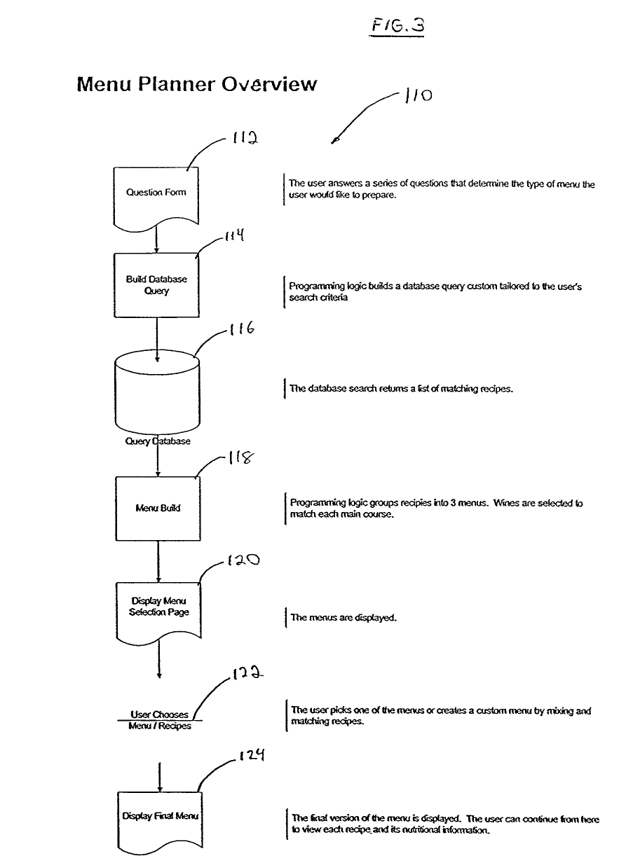

The user accesses the system web site home page through the Internet using its Web browser and chooses the “menu planner” option (the functionality of the menu planner option is displayed generally in logic diagram 110). As described in FIG. 3, the system first formats and displays question screens and forms to the user for input of data regarding the type of menu the user would like to prepare (as is shown in step 112). The user enters the data as requested, and the system accepts the data and its programming logic builds a database search query tailored to the user's search criteria, i.e., the menu criteria and restrictions input (as is shown in step 114). The system transports the search over Internet connections to the system data servers, and the databases are searched according to the input of the user, returning a list of matching recipes (as is shown in step 116). Programming logic then groups the recipes into distinct menus and wines are selected to match each main course (as is shown in step 118). The programming logic collates the recipes into groups, matches the wines and drinks selected with the recipes, and presents them to the user for consideration by displaying them on the user's terminal (as shown in step 120). The user chooses one of the planned menu options or creates a custom menu by mixing and matching recipes and drinks from among the menus and drinks presented on the sample menus (as shown in step 122). The final version of the menu is then displayed (as is shown in step 124). The user may then continue and view each recipe and its corresponding nutritional information. Each of these steps will now be explained in greater detail.

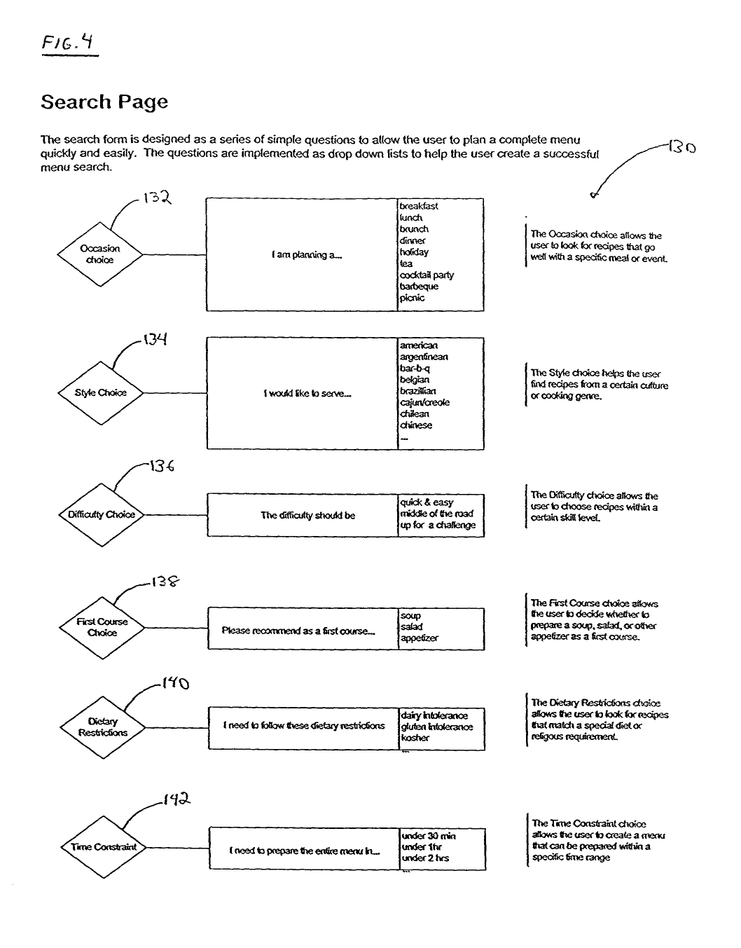

As shown in FIG. 4, a series of search forms are presented to the user (shown generally as 130). Each search form is preferably designed as a series of simple questions to allow the user to plan a complete menu easily. The questions are implemented preferably by drop-down menus. In the preferred embodiment, the user first inputs an occasion choice, which allows the user to look for recipes that complement or match with a specific meal or event (as is shown in step 132). For example, the user can choose an occasion from among Breakfast, Brunch, Lunch, Dinner, Holiday, Tea, Cocktail Party, Barbecue, Picnic, or other choices. The user can also choose how many courses he/she desires to serve and can decide whether to prepare a soup, salad or appetizer as a first course, etc.

Next, the user is asked to make a style choice in order to help the user find recipes from a certain culture or cooking genre (as is shown in step 134). For example, the user may choose from among these styles: American, Argentinean, Belgian, Brazilian, Cajun/Creole, Chilean, Chinese, Cuban, Eastern European, English, Ethiopian, French, German, Greek, Indian, Indonesian, Irish, Italian, Japanese, Korean, Malaysian, Mediterranean, Mexican, Middle Eastern, Moroccan, Scandinavian, South American, Southern, Southwestern, Tex-Mex, Spanish, Swiss, Thai, Turkish, Vietnamese, or other choices. Next, the user is asked to specify a difficulty, or ease of preparation choice, in order to allow the user to choose recipes within a certain cooking skill level, such as quick and easy, middle of the road, up for a challenge, or others (as is shown in step 136).

The user may request a first course type, such as soup, salad, appetizer, or others (as is shown in step 138).

The user can also request that the system search only for recipes that match a special dietary restriction, either nutritional or religious, such as a specific food or ingredient to intolerance, specific food or ingredient allergy, Kosher, Vegetarian, Vegan, or others (as is shown in step 140). The user can also enter a time constraint in order to create a menu that can be prepared within a certain amount of time, such as 30 minutes, one hour, etc. (as is shown in step 142).

In another embodiment, the user may also enter the number of guests that will be served. The user may be prompted by a phrase such as, by non-limiting example “I will be serving ______ guests.” The user could then select the preferred number of guests to be served. The system could then scale the selected recipes in order to provide for ingredient amounts that would correspond to the appropriate number of desired guests. In an embodiment, the recipe data includes the number of servings generated by the recipe, which is adjusted based on the number of guests to be served.

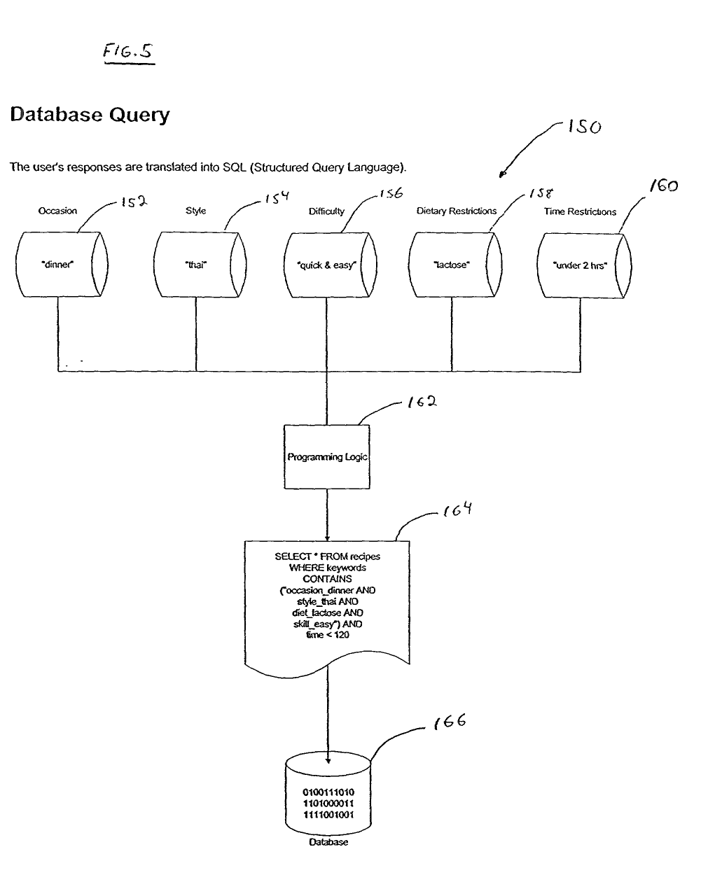

Once the user clicks on the “submit” button or provides some other similar indication that the search restrictions and criteria have been entered, as shown in FIG. 5, the search requirements are translated into the search logic language and presented to the database for matching (this process being shown generally as 150). In the example shown in FIG. 4, the user has input information indicating a desire for recipes that would allow the user to prepare a “quick and easy” 156 “dinner” 152 of “lactose-free” 158 “Thai food” 154 in “under two hours” 160.

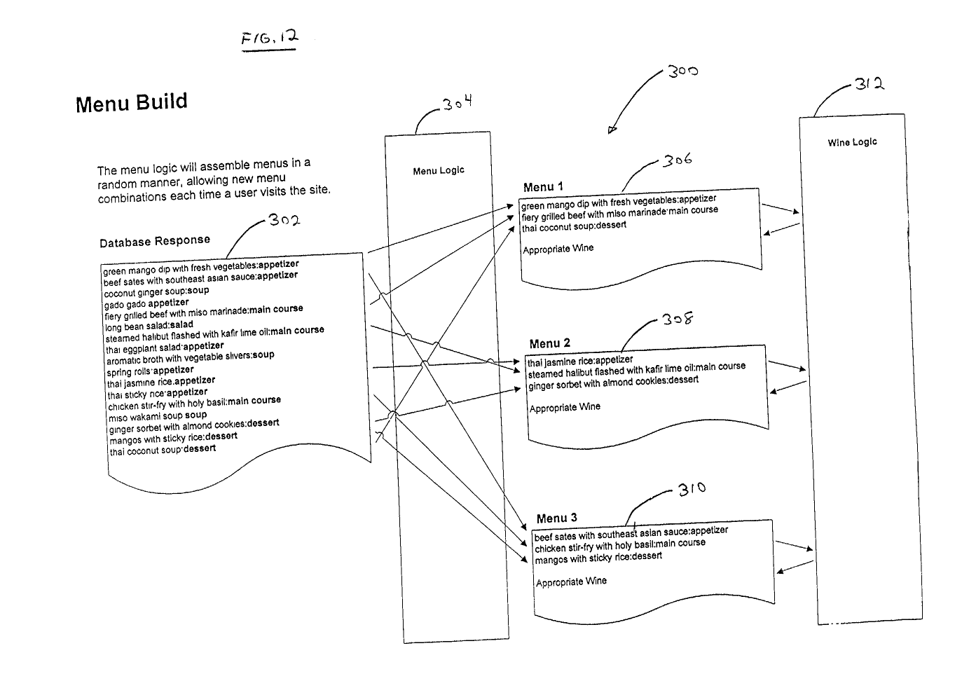

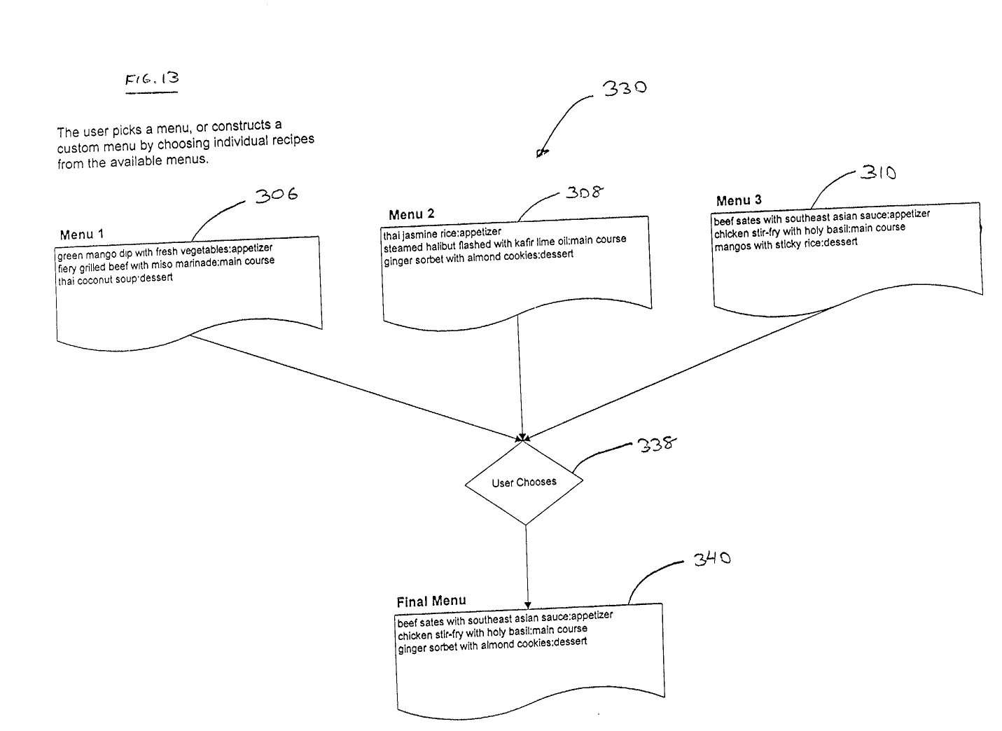

As a result of these search queries, programming logic 162 is used to create appropriate search functions 164 which are translated into structured query language or other appropriate database language (as shown in step 166). The database returns to the user a number of sample menus containing recipes for the specific courses requested by the user and with the desired criteria and restrictions. As shown in FIG. 12, the menu assembly function is used (shown generally as 300). The menu logic 304 randomly selects from the database responses 302 display the recipes to the user by randomly arranging them among a number of suggested menus (shown as 306, 308, 310). With regard to the occasion choice, a recipe may be associated with more than one occasion. Further, a recipe may be suitable for more than one type of dish. For example, a recipe might be suitable fir an appetizer, salad or side dish. Wine logic 312 may then be used to select an appropriate wine selection. In a preferred embodiment, wine logic 312 will base the wine choice on the selected entrée. Alternatively, the wine selection could be based on other components of the menu. Then, as shown in FIG. 13, the user may then either accept one of these planned menus 306, 308, 310 or may mix and match recipes from among the recipes in each planned menu to customize the user's own menu (as is shown in step 338). Then, based on the user's choices, a final menu is generated (as is shown in step 340).

Each recipe may have presented with it a serving size with scaleable functions, ingredients, step-by step instructions and recipe variations, all of which is included in a database of recipe data and associated with the recipe. The recipes may also be supplemented with an abbreviated nutritional content. Upon request by the user, more detailed nutritional information may be provided.

While the recipes may, in one embodiment, be scaled based on the number of expected guests, some recipes may not lend themselves to easy scaling, and thus, will not be scaled by the system. Examples of such non-scaleable recipes could be, certain baking dishes such as pies, quiches, loafs, and souffles, and other items with yeast. In general, if the recipe becomes too complicated due to scaling, then it will not be treated as scaleable, as indicated by a database field.

The mixology planner and wine pairing could operate either in conjunction with the menu planner or separate and apart from the menu planner. For example, with each suggested menu, the system may also suggest a wine pairing or mixology match that complements the menu and recipes suggested therein. Referring again to FIG. 12, this matching could be done at the time that the system presents the user with suggested menus by providing a recommended wine pairing or mixology match with each suggested menu (as is shown in step 312). Alternatively, the system could suggest at least one mixed drink or wine to complement the chosen menu of the user. Here, the system could provide this suggestion after the user has selected his/her desired menu, by accessing a “wine pairing” or “mixology match” button, after which the system would automatically proceed with the wine pairing or mixology match procedure.

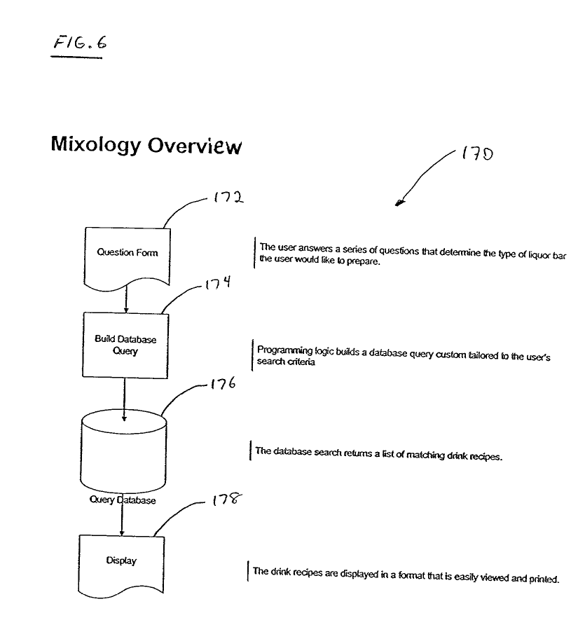

In another embodiment, the wine paring and mixology match could be done separately from the menu planner. This would allow the user to choose a wine or mixed drink with a menu that has already been chosen, either through the system's menu planner or elsewhere. If the menu has already been chosen, the process could operate as follows. As shown in FIG. 6, the mixology planner could be used (shown generally as 170). With respect to the mixology planner, the user first answers a series of questions that determine the type of liquor bar list the user would like to prepare (as shown in step 172). Programming logic then builds a database query custom tailored to the user's search criteria (as shown in step 174). A database search then returns a list of matching drink recipes (as shown in step 176). Then, the drink recipes are displayed for the user (as shown in step 178).

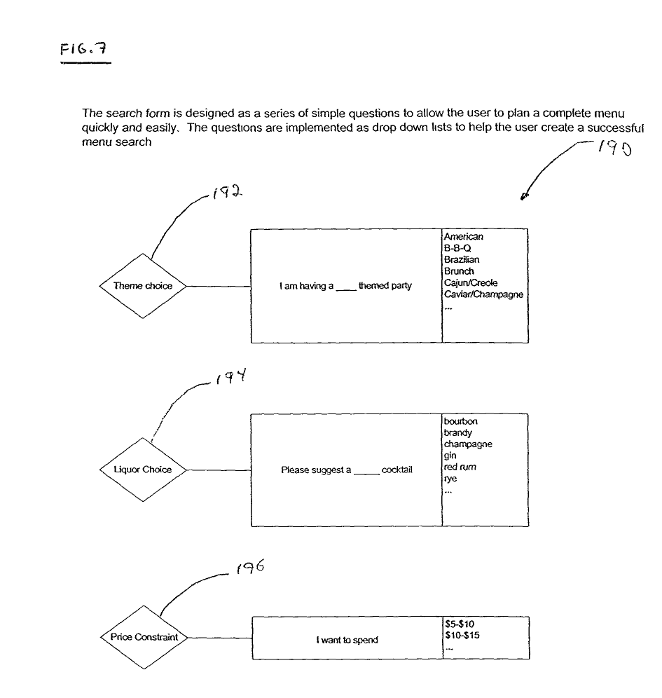

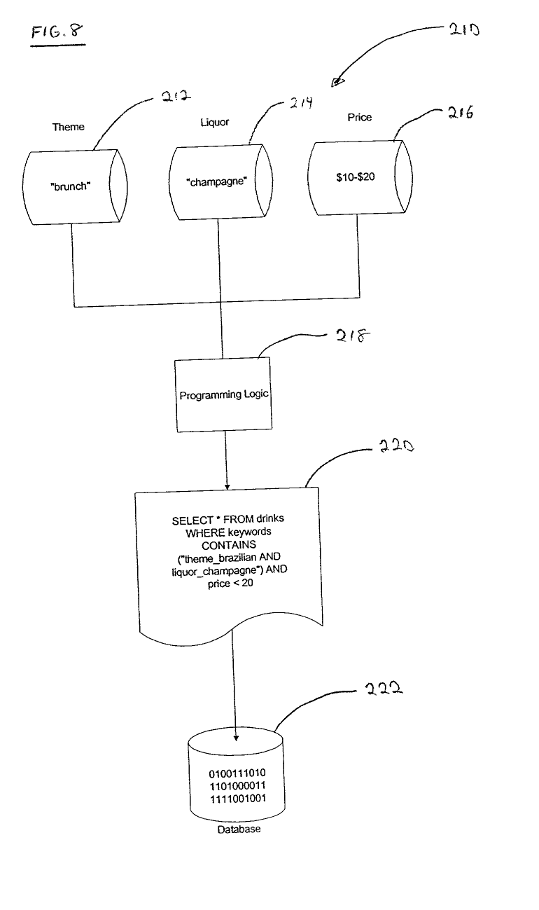

As illustrated in FIG. 7, the mixology search form structure may be used (shown generally as 190). The system queries the user as to the theme choice for the event (as shown in step 192). This theme choice allows the user to look for drink recipes that complement the theme of the event being planned. For example, the user may choose among American, barbecue, Brazilian, brunch, Cajun/Creole, caviar/champagne, etc. The user then can also choose a liquor choice to pick drinks featuring a specific liquor, such as bourbon, brandy, champagne, gin, red rum, rye, etc. (as shown in step 194). The system also allows the user to choose a price constraint so that the drinks chosen will fit within the user's budget (as shown in step 196). As shown in FIG. 8, the user's choices are built by the system's programming logic into a database query custom tailored to the user's search criteria. In this example, the user has chosen a “champagne” 214 “brunch” 212 in which the drinks should cost within a “$10-20 range” 216. As a result of these search queries, programming logic 218 is used to create appropriate search functions 220 which are translated into structured query language or other appropriate database language (as shown in step 222). The database search retrieves a list of matching drink recipes that are recommended to the user.

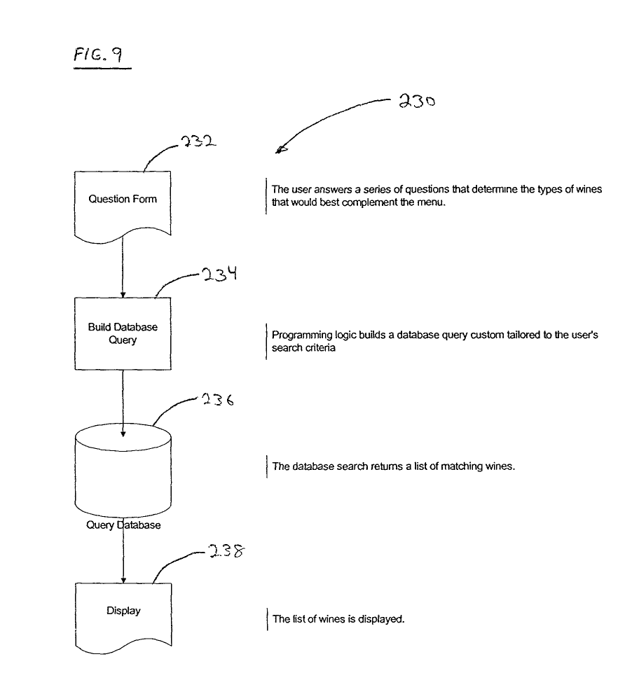

Similarly, as shown in FIG. 9, the wine pairing function may be used (shown generally as 230). With respect to the wine pairing, the user first answers a series of questions that determine the type of wines would best complement the food menu the user plans to prepare (as shown in step 232). The programming logic builds a database query custom tailored to the user's search criteria (as shown in step 234). A data base search then returns a list of matching wines (as shown in step 236). The list of wines is then displayed for the user (as shown in step 238).

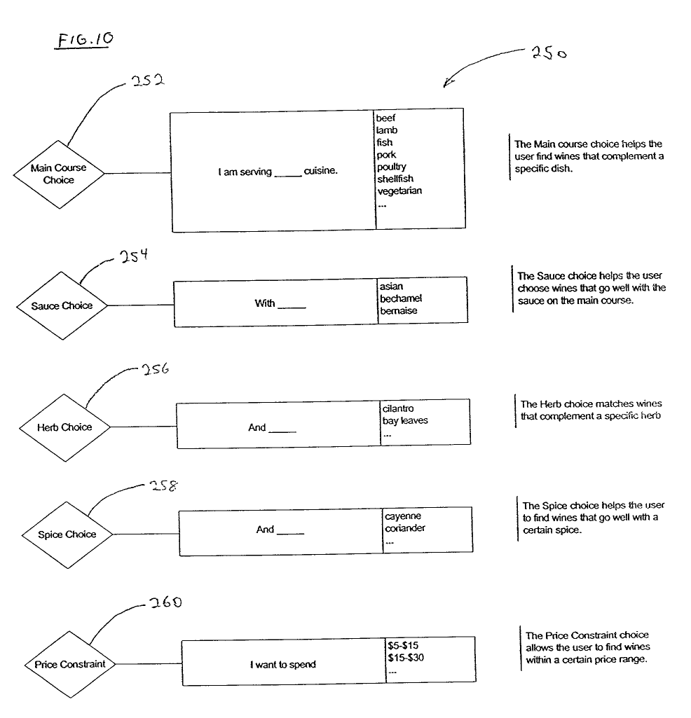

As illustrated in FIG. 10, the wine pairing search form may be used (shown generally as 250). The system first asks the user the type of cuisine being served, such as beef, fish, lamb, pork, poultry, shellfish, vegetarian, or other in order to help the user find a wine that complements a specific dish (as shown in step 252). In order to help the user choose a wine that goes well with a sauce on a main course, the system then asks whether there is any sauce being served with the cuisine, and if so the type of sauce, i.e., whether it is one of Asian, béchamel, bernaise, brown, butter, cream, garlic, ginger, lemon, light stock, Madeira, marinara, marsala, miso, mornay, mustard, olive oil, putanesca, red wine, sabayon, sweet & sour, tomato, veloute, vinaigrette, white wine, or other (as shown in step 254). Next, the system queries the user as to the type of herb (basil, bay leaf, chervil, cilantro, dill, mint, oregano, parsley, rosemary, sage, tarragon, thyme, etc.) or spice (allspice, cardamom, cumin, cayenne, chili, cinnamon, cloves, coriander, dry mustard, fennel seed, ginger, mace, nutmeg, paprika, peppercorns, saffron, turmeric, etc.) is being served or made with the meal, in order to match a wine that complements a specific herb or spice (as shown in steps 256 and 258 respectively). The system also allows the user to choose a price range per bottle so that the wine chosen will fit within the user's budget (as shown in step 260).

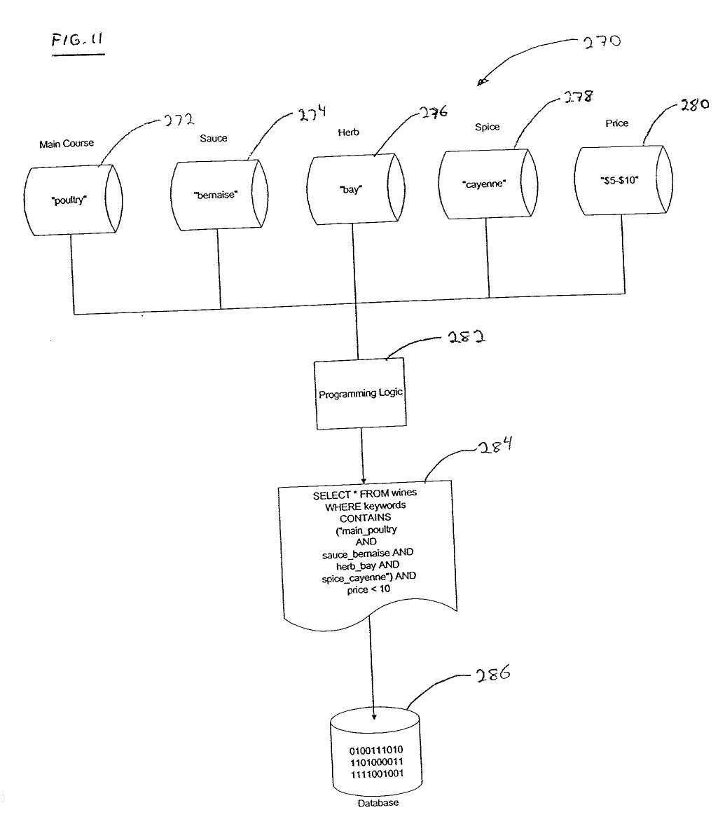

Finally, as shown in FIG. 11, these choices are built by the system's programming logic into a database query custom tailored to the user's search criteria (this process shown generally as 270). In this example, the user has chosen a “poultry” 272 main course, with a “bernaise” 274 sauce, with “bay” 276 as an herb and “cayenne” 278 as a spice with a “$5-$10 range” 280. As a result of the search queries, programming logic 282 is used to create appropriate search functions 284 which are translated into structured query language or other appropriate database language (as shown in step 286). The database search retrieves a list of matching wines or drink recipes that are recommended to the user.

In another embodiment, the wine selection process may also include a choice wherein the user designates a particular country of origin for the wine selection. Another of the possible selection criteria for the wine choice may be grape variety. Choices, by way of non-limiting example, may be: Cabernet Sauvignon, Merlot, Syrah/shiraz, Gamay, Pinot Noir, Zinfandel, White, Chardonnay, Pinot Blanc, Riesling, Gewurztaminer, Pinot Gris/Pinot Grigio, or Sauvignon Blanc. Further, another of the criteria for wine selection may be a particular food to be paired with the wine, such as, by way of non-limiting example, beans, Cheese, Chocolate, Eggs, etc.

Turning now back to the recipes, in another embodiment, the descriptions of the recipes may contain or be associated with keywords. Terms entered in this field will be highlighted or underlined within the procedure of the recipes so that they can clicked on and the meaning viewed while still in that recipe. Keywords are words extracted from the procedure that our user's might not understand. These words may be highlighted within the procedure and the definition or other information accessed.

In another embodiment, the Type of Dish section of the menu planner may have additional parts. First, a user may simply wants to search for recipes without accessing the menu planner. In this embodiment, the same base as used for the menu planner may be accessed. Thus, for example, if the user desires recipes containing chicken, chicken recipes may be provided. Other examples of Type of Dish selections, by way of non-limiting example, are beans, Bread, Cakes/torte, Casserole, Condiment, Cookie/bar, etc.

In another embodiment, a Subset category may be used. The subset category may facilitate a selection of menus wherein if recipes with a high degree of the following elements are used, recipes with these same elements will not be repeated in the menu selection. By way of non-limiting example, if certain recipes contain large amounts of garlic, basil, cream or spice, accompanying recipes will be chosen that do not also contain large quantities of these same or conflicting ingredients so that the resulting menu does not contain recipes that “compete,” conflict, overpower, or generally offend the palate. Other non-limiting examples of selections in the subset category are: Tomato, Spicy, Sweet, Citrus, Cream, Salt, Coconut etc.

In another embodiment, the user, when searching for a type of recipe, may have the ability to sort recipes into related categories. These categories may include, but are not limited to: Holiday Specific, Season, One dish dinners, Contest winners, Kid friendly, Lunch box, Hors d'oeuvres, Low-calorie and Fast & easy.

With regard to the recipe data used for the menu planning, mixology, wine pairing and other related functions, the recipe data may be distributed among several related databases. It is to be known that the present invention is not limited to any particular database structure. For example, in one embodiment, the recipe data may be distributed into an ingredient component, a recipe ingredient component, a dictionary component, a recipe course component, a recipe cuisine component, a recipe occasion component, a recipe restriction component, and a recipe procedure component. Recipe data may be distributed among other related database components as well, such as a course component, a cuisine component, an occasion component, and a restriction component. The present invention, however, may encompass other database structures.

Further, while examples of user criteria have been provided, it is to be understood that the present invention is not limited to the specific examples set forth herein. Accordingly, other menu criteria could be used by including different or additional fields in a database.

Thus, an event menu planning process and system is provided. One skilled in the art will appreciate that the present invention can be carried out in other ways and practiced by other than the described embodiments, yet not departing from the spirit and essential characteristics depicted herein. The present embodiments therefore should be considered in all respects as illustrative, and the present invention is limited only by the claims that follow.

What is claimed is:

1. A method for planning a customized menu of a user, the method comprising:
receiving at least one menu criterion of the user;
generating a list of recipes that correspond to the user's menu criteria;
associating the recipes into one or more potential menus;
transmitting the one or more potential menus to the user;
receiving a final menu selection from the user, the final menu selection being:
one of the one or more potential menus, or
a custom menu based on the list of recipes.

2. The method of claim 1, wherein generating the list of recipes includes querying a database of recipe data based on user's menu criteria.

3. The method of claim 1, wherein receiving the user's menu criteria includes:
providing a plurality of questions;
prompting the user to input responses to said questions; and
receiving the user's responses.

4. The method of claim 3, wherein providing a plurality of questions includes requesting any one or more criteria from the group of criteria consisting of: occasion, style, difficulty, first course, dietary restriction, time constraint and number of guests.

5. A system for planning a customized menu by a user, the system comprising:
a computer system, said computer system having;
a database having recipe data;
a computing device configured to:
receive one or more menu criteria from the user.;
build a database query based on the user's menu criteria;
generate a list of recipes that correspond to the user's menu criteria;
associate the recipes into one or more potential menus;
generate a final menu based on user input.

6. The system of claim 5, wherein the computing device is further configured to:
provide a plurality of questions;
prompt the user to input responses to said questions; and
receive the user's responses.

7. The system of claim 6, wherein the recipe data includes one or more of the following criteria: occasion, style, difficulty, first course, dietary restriction, time constraint, and number of guests.

8. A method for planning a customized menu of a user, the method comprising:
providing menu criteria;
receiving one or more potential menus based on the menu criteria, the potential menus including recipes; and
selecting a final menu based on the one or more potential menus.

9. The method of claim 8, wherein selecting the final menu includes selecting a potential menu.

10. The method of claim 8, wherein selecting the final menu includes selecting recipes from two or more of the potential menus.

11. A method for planning a customized menu of a user, the method comprising:
receiving at least one menu criterion of the user;
generating a list of recipes that correspond to the user's menu criteria;
transmitting the recipes to the user;
receiving a final menu selection from the user, the final menu selection menu based on the recipes.
